(19) United States
(12) Patent Application Publication
(10) Pub. No.: US 2011/0279682 A1
(43) Pub. Date: Nov. 17, 2011

(54) Methods for Target Tracking, Classification and Identification by Using Foveal Sensors

(76) Inventors: Le Li, Hopewell Junction, NY (US); Venkataraman Swaminathan, Bridgewater, NJ (US); Paul D. Willson, Rockaway, NJ (US); Haiping Yu, Hopewell Junction, NY (US); Shenggang Wang, Fishkill, NY (US); Lei Guo, Fishkill, NY (US); Fang Du, Fishkill, NY (US); Peng Li, Chino Hills, CA (US); Mark Massie, Santa Ynez, CA (US)

(21) Appl. No.: 12/945,640

(22) Filed: Nov. 12, 2010

Related U.S. Application Data
(60) Provisional application No. 61/281,097, filed on Nov. 12, 2009.

(51) Int. Cl. H04N 5/225

(52) U.S. Cl. 348/169; 348/E05.024

(57) ABSTRACT

A method of operating a sensor system may include the steps of sensing a predetermined area including a first object to obtain first sensor data at a first predetermined time, sensing the substantially same predetermined area including the first object to obtain second sensor data at a second predetermined time, determining a difference between the first sensor data and the second sensor data, identifying a target based upon the difference between the first sensor data and the second sensor data, identifying a material of the target and determining a target of interest to track based upon the material of the target.

### PRIORITY

The present invention claims priority under 35 USC section 119 and based upon a provisional application with a Ser. No. 61/281,097 which was filed on Nov. 12, 2009.

### FIELD OF THE INVENTION

This invention relates to approaches for target tracking, classification and identification based on spectral, spatial and temporal content changes of an object by using spectrally and spatially foveated sensors.

### BACKGROUND INTRODUCTION

### Target Tracking, Classification and Identification Based on Spatial Content Changes

In the conventional approach, a 2-D imaging sensor is employed to capture pictures of an object. The object is declared to be a target based on its spatial properties such as shape and spatial content. Detected changes relating to the object's position displacement, position displacement speed, position displacement direction and shape variation, etc. are all used for the purpose of target detection, tracking, classification and identification.

For example, Alper Yilmaz et al. proposed a robust approach for tracking targets in forward looking infrared (FLIR)¹ imagery taken from an airborne moving platform. First, the targets are detected using fuzzy clustering, edge fusion and local texture energy. The position and the size of the detected targets are then used to initialize the tracking algorithm. For each detected target, intensity and local standard deviation distributions are computed and tracking is performed by computing the mean-shift vector that minimizes the distance between the kernel distribution for the target in the current frame and the model. To overcome the problems related to the changes in the target feature distributions, the target model is automatically updated. Selection of the new target model is based on the same distance measure that is used for motion compensation. ¹Alper Yilmaz, Khurram Shafique and Mubarak Shah, “Target tracking in airborne forward looking infrared imagery”, Image and Vision Computing, Volume 21, Issue 7, 1 Jul. 2003, Pages 623-635. This reference is incorporated by reference in its entirety.

Recently, an “activity sensing” sensing technique based upon an on-FPA processing architecture has been proposed.² This technique reads out only rich target information from the sensor, in a highly efficient and compressed manner. It detects and accentuates hot spots, variable rate amplitude growth and variable and selectable velocity moving targets in the field of regard while inhibits or rejects non useful information, such as benign background, static objects, sun glints, rural and urban clutter. The targets of interest are detected in a variety of backgrounds and clutter, without an increase in false alarms, vs. a highly optimized set of algorithms implemented in a downstream image processor. ²j T. Caulfield, P. L. McCarley, M. A. Massie, C. Baxter, Performance of Image Processing Techniques for Efficient Data Management on the Focal Plane, Infrared Detectors and Focal Plane Arrays VIII, edited by Eustace L. Dereniak, Robert E. and I, and this reference is incorporated by reference in its entirety. Sampson, Proc. of SPIE Vol. 6295, 62950B, (2006)

The activity sensing algorithms is explained as follows. Light impinges on the photo detector. After signal integration, the data goes into an activity sensing block that uses a capacitive ratioing and comparison circuit to measure the temporal activity over a few frames. Then the activity sensed data enters a follow on threshold stage that filters out the temporal noise and slow drift terms. Those pixels which exhibit a temporal change over a certain period pass the threshold test and then are declared as targets.

FIG. 6 shows the processed data sequence on a data set taken from a spatially variable acuity superpixel imager (VASITM) near the harbor in Santa Barbara, Calif. The upper set of images are full high resolution 14 bit pixel outputs, and the lower image is the thresholded single bit output of the activity sensing algorithm. The activity sensing images illustrate that people and cars are passed as active targets. The car is now clearly delineated and observable within the surrounding clutter of trees and the fence versus in the standard full frame output image. This illustrates that low bandwidth activity based algorithms improves the object recognition and reduce the detection time of the moving car. The binary output activity threshold has less than 1000 pixels encoded with a single bit. In this example, 1,024 1-bit pixels have passed through the “activity filter”. The amount of data required to construct this full 1-bit pixels image is (1024*1024 pixels*1 bit)=1 Mbits/frame. The amount of data required to store a full 14-bit representation for all pixels in the frame=(1024*1024*16 bits/pixel)=16 Mbits/frame. 16 bits are typically used to store 14 bit data, leaving 2 bits for additional information if needed. The ratio of (full representation)/(1-bit representation) in this case=16/1=16.

Since, in this example, the focal plane array identifies the active pixels and furthermore reduces the bit depth of the pixel to a single bit, the reduced data set required to represent the salient image information will lead to a more efficient means to detect targets of interest.

A multi-spectral image is composed of copies of the same scene but captured in different spectral bands across the electromagnetic spectrum. The spectral bands may be created by band pass filters in the optics or by the use of instruments that are sensitive to particular wavelengths. Multi-spectral imaging can allow extraction of additional information that the human eye fails to capture with its visible receptors. Multi-spectral imaging was originally developed for space-based imaging.

Multi-spectral images are the main type of images acquired by Remote Sensing (RS) radiometers. Dividing the spectrum into many bands, multi-spectral is the opposite of panchromatic which records only the total intensity of radiation falling on each pixel. Usually satellites have 3 to 7 or more radiometers (Landsat has 7). Each one acquires one digital image (in remote sensing, called a scene) in a small band of visiblespectrum that ranges from 0.7 micrometers (μm) to 0.4 μm and into the infra-red region from 0.7 μm to 10 or more, which are classified as NIR-Near InfraRed, MIR-Middle InfraRed and FIR-Far InfraRed or Thermal. In the Landsat case the 7 scenes comprise a 7 band multi spectral image. Multispectral images with more numerous bands or finer spectral resolution or wider spectral coverage may be called “hyperspectral” or “ultra-spectral”.

Using hyperspectral algorithms for automated target detection has been reported. For example, a forward neural network based algorithm³ has been recommended for automated target detection. This approach builds on the least squares paradigm based on the neural network (NN). Featuring nonlinear properties and making no assumptions about the distribution of the data, the algorithm promises fast training speed and high classification accuracy. ³Suresh Subramanian, Nahum Gat, Michael Sheffield, Jacob Barhen, Nikzad Toomarian, Methodology for hyperspectral image classification using novel neural network, Algorithms for Multispectral and Hyperspectral Imagery III, SPIE Vol. 3071—Orlando, Fla., April 1997. This reference is incorporated by reference in its entirety.

Technically, the algorithm, introduces solutions involving a sequence of alternating directions of singular value decompositions (ADSVD) for error minimization. Second, it uses data reduction schemes such as principal component analysis (PCA)⁴ and simultaneous diagonalization of covariance matrices. Third, it utilizes the concept of sub-networks, which train a single network to identify one particular class, only instead of using a single network to identify all classes. ⁴R. A. Schowengerdt, Techniques for Image Processing and Classification in Remote Sensing, Academic Press (1983). This reference is incorporated by reference in its entirety.

High classification accuracy is obtained that enhances the separation between classes by leveraging on the advantage of the generalized eigen value (GEV) technique. As reported, for a limited test set selected from the Moffett Field image acquired by the AVIRIS sensor (224 bands), extremely rapid training times (few seconds per class) and 100% classification accuracy have been achieved when using no more than a dozen pixels/class for training; all were performed on a PC platform.

Polonskiy et al. disclosed an invention of a method for the classification of spectral data such as multi-spectral or hyper-spectral image pixel values or spectrally filtered sensor data.⁵ In this approach, spectral data classification uses the decoupling of target chromaticity and lighting or illumination chromaticity in spectral data and the sorting and selection of spectral bands by values of a merit function to obtain an optimized set of combinations of spectral bands for classification of the data. The decoupling is performed in ‘delta-log’ space. For a broad range of parameters, correction of lighting chromaticity may be obtained by use of an equivalent “Planck distribution” temperature. Merit function sorting and band combination selection is performed by multiple selection criteria. The method achieves reliable pixel classification and target detection in diverse lighting or illumination, especially in circumstances where lighting is non-uniform across a scene, such as with sunlight and shadows on a partly cloudy day or in “artificial” lighting. ⁵Leonid Polonskiy, et al., “Method For Spectral Data Classification And Detection In Diverse Lighting Conditions”, WO/2007/098123,

This reference is incorporated by reference in its entirety.

The spectral data classification method enables operator supervised and automated target detection by sensing spectral characteristics of the target in diverse lighting conditions. A hyperspectral or multispectral camera records the data in each spectral band as a radiance map of an object or a scene where a pixel value depends on the spectral content of the incident light, spectral sensitivity of the camera, and the spectral reflectance (or transmittance) of the target. For target detection, recognition, or characterization, it is the spectral reflectance of the target that is of interest.

To perform the desired target detection and tracking, a spectral sensor is desirable. Candidate spectral sensors include hyperspectral and multispectral sensors, as well as the most recently proposed spectrally and spatially foveated sensor.

A hyperspectral sensor collects and processes information from across the electromagnetic spectrum. Hyperspectral sensors collect information as a set of ‘images’. Each image represents a range of the electromagnetic spectrum and is also known as a spectral band. These ‘images’ are then combined and form a three dimensional hyperspectral cube for processing and analysis. The precision of these sensors is typically measured in spectral resolution, which is the width of each band of the spectrum that is captured. If the scanner picks up on a large number of fairly small wavelengths, it is possible to identify objects even if said objects are only captured in a handful of pixels. However, spatial resolution is a factor in addition to spectral resolution. If the pixels are too large, then multiple objects are captured in the same pixel and become difficult to identify. If the pixels are too small, then the energy captured by each sensor-cell is low, and the decreased signal-to-noise ratio reduces the reliability of measured features. Hyperspectral data is a set of contiguous bands (usually by one sensor).

A multispectral sensor contains data from tens to hundreds of bands. The distinction between hyperspectral and multispectral is usually defined as the number of spectral bands. Different from hyperspectral data that contains hundreds to thousands of bands, multispectral data is a set of optimally chosen spectral bands that are typically not contiguous and can be collected from multiple sensors.

A spectrally and spatially foveated multi/hyperspectral sensor is such a sensor that models human eyes. The human eye is a foveating sensor. That is, the highest acuity or concentration of sensors is in the central portion of the sensor. The highest spatial and spectral resolution is in the center of the sensor and decreases towards the edge. Color is not as rich when seen on the edges of the Field of View (FOV) for the eye. The foveating visual multi/hyperspectral sensor has high spatial and spectral resolution within the regions of interest (ROIs), as opposed to other regions of the image. Optimally, the resolution would change in a smooth fashion.

### SUMMARY

A method of operating a sensor system may include the steps of sensing a predetermined area including a first object to obtain first sensor data at a first predetermined time, sensing the substantially same predetermined area including the first object to obtain second sensor data at a second predetermined time, determining a difference between the first sensor data and the second sensor data, identifying a target based upon the difference between the first sensor data and the second sensor data, identifying a material of the target and determining a target of interest to track based upon the material of the target.

The first sensor data may be hyperspectral data, and the second sensor data may be hyperspectral data.

The first sensor data may be multi spectral data, and the second sensor data may be multispectral data.

The difference may be signal amplitude data, and the signal amplitude data may be brightness data.

The signal amplitude data may be intensity data.

A method for operating a sensor system may include the steps of monitoring a predetermined area in a staring mode without spectral scanning, finding a moving target within the predetermined area, tracking the target based on pixel data, identifying the shape of the target based upon the pixel data, performing a foveated spectral scan over the target using high spectral resolution and identifying the material of the target based upon the foveated spectral scan.

The step of monitoring may be monitored with fine spatial resolution, and the step of performing may be performed with high spectral resolution in a first predetermined area.

The identification step may be made by comparing a spectral signature of the target to predetermined spectrums, and the step of performing may be performed with a coarse spectral resolution and a second predetermined area.

A method for operating a sensor system may include the steps of performing a scan over a first predetermined area with at least a low or a moderate spatial resolution. performing a classification over the image frame data; finding a target having a material which matches a predetermined material, performing a foveated spatial scan to reimage the area with the highest spatial resolution.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a first sensor scanning a first area;

FIG. 2 illustrates a second scanner scanning the first area;

FIG. 3a is a portion of a flowchart of the present invention;

FIG. 3b is a second portion of the flowchart of the present invention;

FIG. 5 illustrates another flowchart of the present invention;

FIG. 6 illustrates a sensor detected scene.

### DETAILED DESCRIPTION

It is then an object of the present invention to provide a method for target classification, identification, and tracking based on the target spectral content change or variation.

It is further an object of the present invention to provide a method for target classification, identification, and tracking based on the target spectral content change or variation together with the target position, position displacement, moving direction, moving speed, and shape change or variation.

It is further an object of the present invention to provide a method for target classification, identification, and tracking based on the target spectral content change or variation by using a hyperspectral and/or a multispectral sensor.

It is further an object of the present invention to provide a method for target classification, identification, and tracking based on the target spectral content change or variation by using a spectrally and spatially foveated sensor.

In the first embodiment of this invention disclosure, using a spectral sensor for target detection and tracking based on the target spectral content change or variation is disclosed. The following general exemplary procedures are described for detecting and tracking a target via a spectral sensor 101.

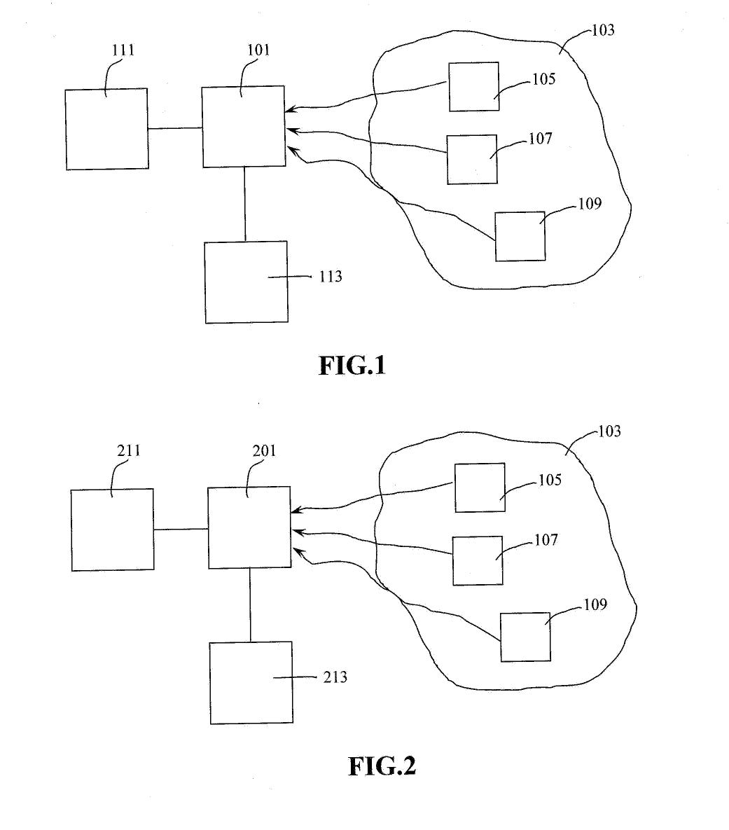

FIG. 1 illustrates a spectral sensor 101 which may be positioned to scan a first predetermined area 103 which may include a first object 105, a second object 107 and a third object 109 which may be referred to as targets. The first object 105, the second object 107 and the third object 109 may be a vehicle, an animal, a human, a building, trees and bushes or other types of objects.

The sensor 101 performs a first scan at a first predetermined time over a wide predetermined area 103 to collect the first set of hyperspectral or multispectral data from at least the first object 105, the second object 107 and the third object 109 and which may be stored in a database 113.

The sensor 101 performs a second scan over substantially the same area 103 to collect the second set of hyperspectral or multispectral data from at least the first object 105, the second object 107 and the third object 109 and which may be stored in a database 113.

The associated computer 117 (or the ROIC itself) obtains the first set of data and the second set of data and compares the first and second set image data frame by frame and pixel by pixel. For example, the pixel x^{m}ᵢⱼ(1) in the m^{th} frame in the first set data is compared to the corresponding pixel x^{m}ᵢⱼ(2) in the corresponding m^{th} frame in the second set data, and so on for each pixel in the first and second data set.

If the two compared pixels pixel x^{m}ᵢⱼ(1) and pixel x^{m}ᵢⱼ(2) show difference greater than a predetermined or threshold difference in signal amplitude (e.g., brightness or intensity), this pixel location is declared to be one of the target pixels. It should be mentioned that the difference between the pixel signals may be caused by either spatial movement or spectral content change of the target at that pixel location. If the target/object 105, 107, 109 is stationary, then the difference between the first set of data and the second set of data is solely caused by the target spectral content change.

If the two pixels pixel x^{m}ᵢⱼ(1) and pixel x^{m}ᵢⱼ(2) show no difference or the difference is less than the predetermined or the threshold difference of the detected signals, the sensor continues to scan the first predetermined area 103 to obtain a third scan of the predetermined area 103 and to generate a third set of data. The second set of data replaces the first set of data within the database 103 and the third set of data replaces the second set of data within the database 103. The comparison described above is repeated continuously.

Once a target pixel is declared, the sensor processor starts the identification phase to identify the shape of the target by processing all the pixels from the predetermined area 103 that show the substantially the same signal difference. For example, if the target is a military tent covered with a camouflage net, the target could emit or reflect spectral components in electromagnetic radiation that are different in the morning and at noon.

The sensor processor 117 further processes the target spectral data to identify the material of which the target is made. The identification of the material can be performed by the processor 117 comparing the spectral signature of the target 105, 107, 109 against the pre-identified spectral data which may have been previously stored within the database 113 via an algorithm, for example, the feed forward neural network.

Once the target 105, 107, 109 is declared to be of interest, the target is then tracked. Otherwise, the sensor continues the operation until another target is detected, identified and eventually tracked.

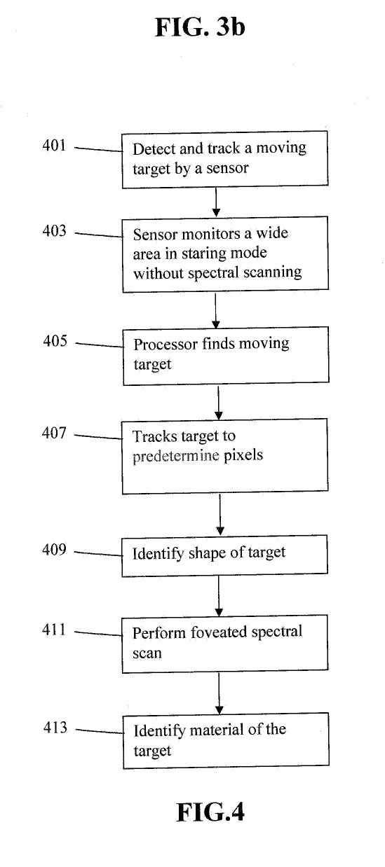

FIGS. 3a and 3b, collectively referred to as FIG. 3 illustrates a flowchart of the above description and illustrates in step 301 that an area is scanned to collect data. In step 303, the area is rescanned and data is collected. In step 305, the first scan data which was obtained in the first scan in step 301 may be compared with the second scan data which was obtained in the second scan in step 303. In step 307, if there is a difference between the first scan data and the second scan data in step 309 is executed. If there is no difference between the first scan data and the second scan data, the next pixel is incremented in step 311 and control is returned to step 301 to scan the area and collect the first scan data for the next pixel. If there is a difference, then control passes to step 319. The pixel is then defined as a target pixel. In step 311, the material of the target pixel is identified, and in step 313, it is determined if the target is a target of interest. If the target is not a target of interest then control passes to step 301 and if the target is a target of interest then the target is tracked in step 315.

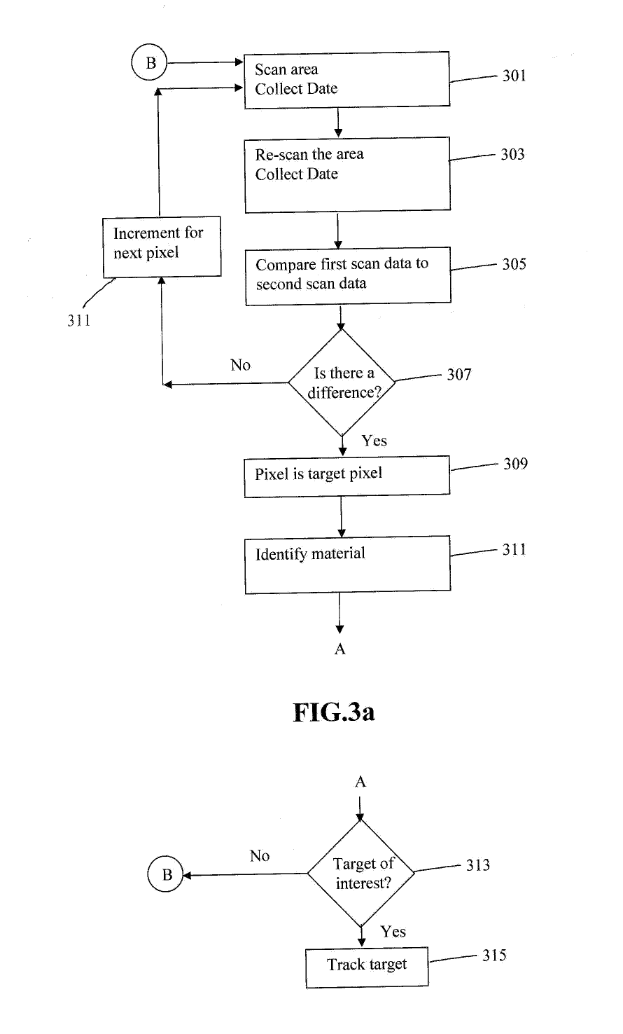

In the second embodiment of this invention disclosure as shown in FIG. 2, using for example a spectrally and spatially foveated multi/hyperspectral sensor 201 for target detection and tracking based on the spectral content change or variation of the target/object 105, 107, 109 is disclosed. The following procedures are for detecting and tracking a target/object 105, 107, 109 via such a spectrally and spatially foveated sensor 201. Exemplary approaches are suggested.

### Detecting and Tracking a Moving Target by Using a Spectrally and Spatially Foveated Sensor

The sensor 201 monitors a wide area (wide FOV) in a first predetermined staring mode with programmable coarse and fine spatial resolution but without spectral scanning.
The processor 111 which may be a sensor on-chip processor finds a moving target(s) 105, 107, 109 via the implemented algorithm, as described by J. T. Caulfield in Reference (2) which has been incorporated by reference in its entirety;

The sensor 201 by the processor 111 tracks the target 105, 107, 109 to predetermined pixels or specific pixels x^{m}ᵢⱼ.

The sensor 201 identifies the shape of the target through the on-chip processor 211 (for example, the target can be a moving torpedo, or a shark, which may look alike at a distance).

The sensor 201 performs a foveated spectral scan, which is an High Speed HS scan over the identified target area which may be a portion of the first predetermined area 103 with a high spectral resolution while keeping the rest of the area which may be the remaining portion of the first predetermined area 103 either un-scanned or scanned with a coarse spectral resolution with a coarse spatial resolution.

The sensor 201 transfers the captured HS image frames to the off board computer which may be the computer 211.

The off board computer 211 processes the target spectral data obtained from the sensor 201 to identify the material of which the target is made. The identification can be performed by comparing the spectral signature of the target 105, 107, 109 against the pre-stored material spectrum data which may be stored within the data base 213 via an algorithm, for example, the feed forward neural network.

The sensor system which may include the sensor 201, the processor 211 and the database 213 completes the mission by accurately identifying and tracking the target.

FIG. 4 illustrates a flowchart showing the above steps. In step 401, the sensor detects and tracks a moving target, and in step 403 the sensor monitors a wide area in a staring mode without spectral scanning.

In step 405, the processor finds the moving target, and in step 407, the target is tracked to predetermined pixels. In step 409, the shape of the target is identified, and in step 411, a foveated spectral scan is performed. In step 413, the material of the target is identified.

An alternative approach for detecting and tracking a non-moving target by using a spectrally and spatially foveated sensor follows.

The sensor 201 performs an initial high-speed HS scan over a wide area (wide FOV) for example the first predetermined area 103 with a low to moderate spatial resolution to save scan time.

The sensor 201 transfers the captured HS image frames to the off board computer 211.

The off board computer 211 performs the classification to classify elements or compounds of the target according to certain chemical functional or structural properties over the entire image frame or a portion of the frame image using the implemented algorithm.

The classification finds one or more suspicious targets 105, 107, 109 made of the materials of interest (e.g., the target belongs to metal category rather than vegetation or animal muscle category);

The sensor performs a foveated spatial scan to re-image the suspicious area(s) which may be a portion of the first predetermined area 103 with the highest spatial resolutions while keeping the remaining area of the first predetermined area 103 with low resolution (at this time the sensor is still in wide FOV mode without losing the awareness of the remaining area during this operation). This step yields the well-defined shape or contour of the suspicious targets (e.g., the target belongs to a floating mine rather than a floating Coke can).

The sensor system completes the contact identification mission.

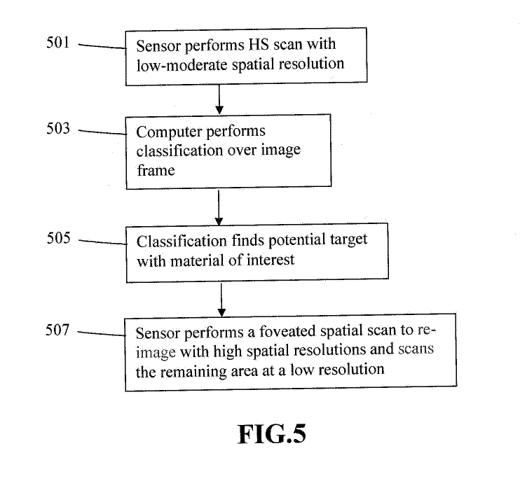

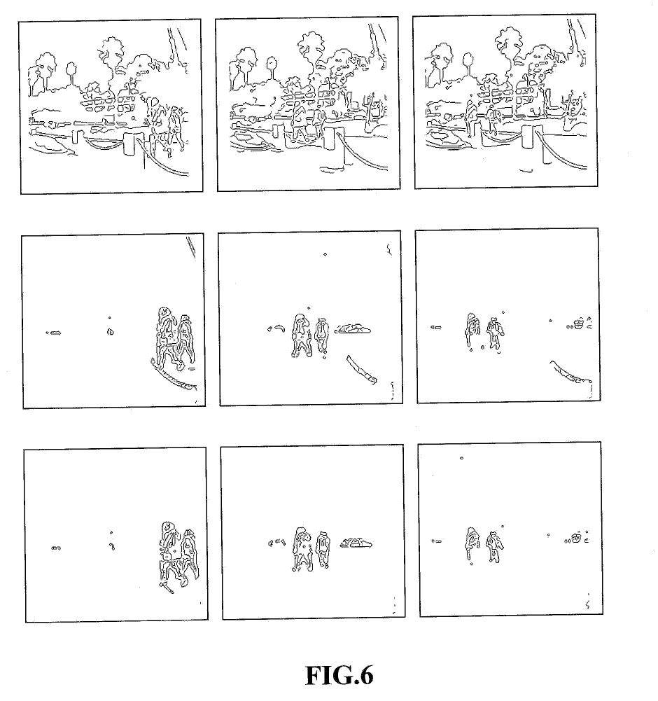

The algorithms as well as the advanced processing software rely on hyperspectral channel selection as a function of background and target spectra and for optimizing search routines. The algorithms for automated zoom search routines should vary with altitude and target parameters, resulting in improvements to tracking reliability and functionality. The hyperspectral imagery processing algorithms for tracking targets of interest take advantage of eliminating unwanted scene data through either the foveal and/or automating zoom operations for search routines.
As compared to conventional HS sensor, the foveal HS sensor does not need to compress the image data prior to transfer. Furthermore, the foveal HS sensor needs much less time in computing the algorithm for target identification.
The spectrally and spatially foveated sensor may have the ability to perform on-chip change detection, whether the change is a result of spectral or spatial signal variation. A control signal sent to the ROIC will indicate to it that an HS scan is being performed; on-chip change detection may then be interpreted by the ROTC as being caused by either a spectral or spatial time-varying signal difference.
FIG. 5 illustrates the above method. FIG. 5 illustrates, in step 501 that the sensor performs a HS scan with low to moderate spatial resolution and illustrates in step 503 that the computer performs classification over image frames. In step 505, the classification finds a potential target with the material of interest, and in step 507, the sensor performs a foveated spatial scan to reimage with high spatial resolution and scans the remaining area at a low resolution.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A method of operating a sensor system, comprising the steps of:
sensing at least a first predetermined area including at least a first object to obtain first sensor data at a first predetermined time;
sensing the substantially same predetermined area including the first object to obtain second sensor data at a second predetermined time;
determining a difference between the first sensor data and the second sensor data;
identifying a target based upon the difference between the first sensor data and the second sensor data;
identifying a material of the target;
determining a target of interest to track based upon the material of the target.

2) A method of operating a sensor system as in claim 1, wherein the first sensor data is hyperspectral data.

3) A method of operating a sensor system as in claim 1, wherein the second sensor data is hyperspectral data.

4) A method of operating a sensor system as in claim 1, wherein the first sensor data is multi spectral data.

5) A method of operating a sensor system as in claim 1, wherein the second sensor data is multi spectral data.

6) A method of operating a sensor system as in claim 1, wherein the difference is signal amplitude data.

7) A method of operating a sensor system as in claim 6, wherein the signal amplitude data is brightness data.

8) A method of operating a sensor system as in claim 6, wherein a signal amplitude data is intensity data.

9) A method for operating a sensor system, comprising the steps of;
monitoring at least a first predetermined area in a staring mode without spectral scanning;
finding at least a moving target within the predetermined area tracking the target based on pixel data;
identifying the shape of the target based upon the pixel data;
performing a foveated spectral scan over the target using high spectral resolution;
identifying the material of the target based upon the foveated spectral scan.

10) A method of operating a sensor system as in claim 9, wherein the step of monitoring is monitored with fine spatial resolution;

11) A method of operating a sensor system as in claim 9, wherein the step of performing is performed with high spectral resolution in a first predetermined area.

12) A method of operating a sensor system as in claim 10, wherein the identification step is made by comparing a spectral signature of the target to predetermined spectrums.

13) A method of operating a sensor system as in claim 11 wherein the step of performing is performed with a coarse spectral resolution in at least a second predetermined area.

14) A method for operating a sensor system, comprising the steps of
performing a scan over at least a first predetermined area with at least a low or a moderate spatial resolution;
performing a classification over the image frame data;
finding a target having a material which matches a predetermined material;
performing a foveated spatial scan to reimage the area with higher spatial resolution.

15) A sensor system, comprising:
a sensor for sensing at least a first predetermined area including at least a first object to obtain first sensor data at a first predetermined time;
the sensor sensing the substantially same predetermined area including the first object to obtain second sensor data at a second predetermined time;
a computer to determine a difference between the first sensor data and the second sensor data;
the computer identifying a target based upon the difference between the first sensor data and the second sensor data;
the computer identifying a material of the target;
the computer determining a target of interest to track based upon the material of the target.

16) A sensor system as in claim 15, wherein the first sensor data is hyperspectral data.

17) A sensor system as in claim 15, wherein the second sensor data is hyperspectral data.

18) A sensor system as in claim 15, wherein the first sensor data is multi spectral data.

19) A sensor system as in claim 15, wherein the second sensor data is multi spectral data.
